(19) United States
(12) Patent Application Publication
(10) Pub. No.: US 2015/0332594 A1
(43) Pub. Date: Nov. 19, 2015

(54) SYSTEM AND METHOD FOR MEMORIZING A NARRATIVE

(71) Applicant: Mohammed Naji, Glendora, CA (US)

(72) Inventor: Mohammed Naji, Glendora, CA (US)

(21) Appl. No.: 14/279,030

(22) Filed: May 15, 2014

(51) Int. Cl. G09B 5/00

(52) U.S. Cl. CPC G09B 5/00

(57) ABSTRACT

The system and method for memorizing a narrative comprises a user interface equipped with common hardware including a pointing device, microphone, and a display. It further comprises an analogue to digital converter for converting analogue speech to digital signals, a comparator for comparing digital signals to a narrative stored and accessible from the main memory of a computing device, and an alert or for alerting a user when the comparison of digital signals to the stored narrative mismatches.

### FIELD OF THE INVENTION

The field of the invention is speech recognition hardware and software and more specifically, technology related to the memorization of a narrative.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Memorization can be a difficult process. Of course, the longer the narrative that one is trying to memorize, the more difficult this can become. Memorization of a narrative requires patience, hard work, and stamina.

There are various methods for memorizing a particular narrative. These may include auditory, visual, vocal, and hands on methods, or any combination of the four, or other methods. For example, a thespian trying to memorize the narrative of a particular play may first listen to the play by watching a live theatrical event, to get the basis of the particular narrative impressed upon her mind. She may then read a transcript of the narrative in its entirety, seeing the play from a different perspective. She then may engage in the tedious task of handwriting the transcript, word for word, forcing her to look at each letter of each word, sentence, paragraph, and page. Page after page of the transcript may then be processed through her mind, through her hands, and eventually through the tip of a number two pencil onto a fresh canvas of white paper, until she has before her two transcripts—one type-faced, the other handwritten. After having transcribed the play she may then vocalize it. This entire process, or portions of the process may be repeated over and over again until that moment in time finally arrives when she has internalized the entirety of the play and no longer requires the visual of the original transcript or reviewing of her handwritten version. She attains the ability to perform the play herself, having sown the seeds into her mind, which she may then nurture and grow through her own interpretation and personal delivery to an audience.

Although this process of memorization is familiar, it is time consuming. One method to save time in the process memorization utilizing all of the techniques discussed above includes typing, rather than handwriting a particular narrative. For example, one may use a computer to type flashcards to memorize particular elements of a subject. This process has the drawback, however, of severe disorganization in the event that the flashcards are inadvertently dropped.

To address this issue, entirely computer based flashcards have been developed. Such flashcards may be created and stored on one's personal computer, or in the cloud. Computerized flashcards allow the user to view either the obverse or transverse of any particular card, with a click of a button. Yet the drawback of this process is that it utilizes the same concepts already discussed. With memorizing a play, a thespian may still need to see the play, type it into flashcards, and vocalize based on obverse prompts. She would have to do this until the play was memorized.

Doubtless, there are other systems and methods used for the memorization of a particular narrative using either online or offline processes. One particular feature that all of these processes lack, however, is the ability to utilize speech recognition technology to assist a person in internalizing a narrative. There is a need in the art for a system and method for memorizing a narrative that saves as much preparation time as possible, that is paperless, and that utilizes one's own voice in the implementation of memorization. It is to these ends that the present invention has been developed.

### BRIEF SUMMARY OF THE INVENTION

To minimize the limitations in the prior art, and to minimize other limitations that will be apparent upon reading and understanding the present specification, the present invention describes a system and method for the memorization of a narrative.

In accordance with one embodiment of the present invention, a user interface, comprises a computer program wherein the computer program is stored in a memory of a computing device, and wherein the computer program is adapted to be executed to implement a method for memorizing a narrative, comprising the steps of receiving a first narrative, storing the first narrative in the memory, receiving a second narrative, comparing the first narrative to the second narrative, determining whether the first narrative matches the second narrative, and sending an alert when comparing the first narrative to the second narrative reveals discrepancies.

A device for facilitating memorization of a narrative, in accordance with one embodiment of the present invention, comprises a user interface, a processor, a memory, and one or more programs stored in the memory and configured to be executed by the processor, the one or more programs including: instructions for receiving a first narrative, instructions for storing the first narrative in the memory, instructions for receiving a second narrative, instructions for comparing the first narrative to the second narrative, instructions for determining whether the first narrative matches the second narrative, and instructions for sending an alert when comparing the first narrative to the second narrative reveals discrepancies.

A method for memorizing a narrative via a user interface, in accordance with one embodiment of the present invention, comprises receiving, by a user interface, a first narrative wherein receiving the first narrative comprises receiving a digital input, storing the first narrative in a memory accessible by the user interface, wherein storing the first narrative includes storing one or more punctuation characters, wherein the one or more punctuation characters serve the purpose of dividing the first narrative into one or more sentences, receiving, via the user interface, a second narrative wherein receiving the second narrative comprises converting an analogue input into a digital input, comparing the first narrative to the second narrative, wherein the comparison of the first narrative to the second narrative is in near real-time, determining whether the first narrative matches the second narrative, and sending an alert when comparing the first narrative to the second narrative reveals discrepancies, and wherein the alert is immediately sent when a discrepancy is revealed when comparing the first narrative to the second narrative.

It is an objective of the present invention to save time.

Is another objective of the present invention to promote organization.

It is yet another objective of the present invention to use speech recognition technology to assist in the process of memorizing a particular narrative.

These and other advantages and features of the present invention are described herein with specificity so as to make the present invention understandable to one of ordinary skill in the art.

### BRIEF DESCRIPTION OF THE SEVERAL VIEWS OF THE DRAWINGS

Elements in the FIGS. have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1 is a block diagram of a computer system upon which an embodiment of the invention may be implemented.

FIG. 2 is a block diagram of a system for memorizing a narrative.

FIG. 3 depicts a flowchart describing one method of memorizing a narrative utilizing a smart-phone, in accordance with the present invention.

FIG. 4A depicts a user interface on a smart-phone for memorizing a narrative, illustrating one possible screenshot n accordance with an embodiment of the present invention.

FIG. 4B depicts a user interface on a smart-phone for memorizing a narrative, illustrating one possible screenshot in accordance with an embodiment of the present invention.

FIG. 4C depicts a user interface on a smart-phone for memorizing a narrative, illustrating another possible screenshot in accordance with an embodiment of the present invention.

FIG. 4D depicts a user interface on a smart-phone for memorizing a narrative, illustrating yet another possible screenshot in accordance with an embodiment of the present invention.

FIG. 4E depicts a user interface on a smart-phone for memorizing a narrative, illustrating yet another possible screenshot in accordance with an embodiment of the present invention.

FIG. 5A depicts a transcript of a particular narrative.

FIG. 5B is a depiction of the narrative from FIG. 5A as stored in the memory of the system as an ordered narrative, in accordance with one embodiment of the present invention.

FIG. 6A depicts another transcript of a particular narrative.

FIG. 6B is another depiction of the narrative from FIG. 6A as stored in the memory of the system as an ordered narrative.

FIG. 7 depicts a flowchart illustrating a method of utilizing a computing device to memorize a narrative, in accordance with one embodiment of the present invention.

FIG. 8 depicts a flowchart illustrating a method of utilizing a computing device to memorize a narrative, in accordance with one embodiment of the present invention.

### DETAILED DESCRIPTION OF THE INVENTION

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

A system for memorizing a narrative, in accordance with the present invention, is generally comprised of a computing system, which may include a smart-phone, a laptop computer, a tablet, a personal computer, or other computing device or user interface. This computing system may be programmable to receive analogue utterance inputs from a user and convert these utterances into a digital format or signal that is recognizable by the computer system. Once converted, the digitized utterances may be compared to a narrative stored within the memory of the computer system. So long as the utterances match, the user may continue to speak. Where there is a mismatch, however, between what is stored in the memory of the computer system and what is said, the user is alerted. This helps to facilitate the method of memorizing a narrative, as the user may then repeat the process until she receives no further alerts.

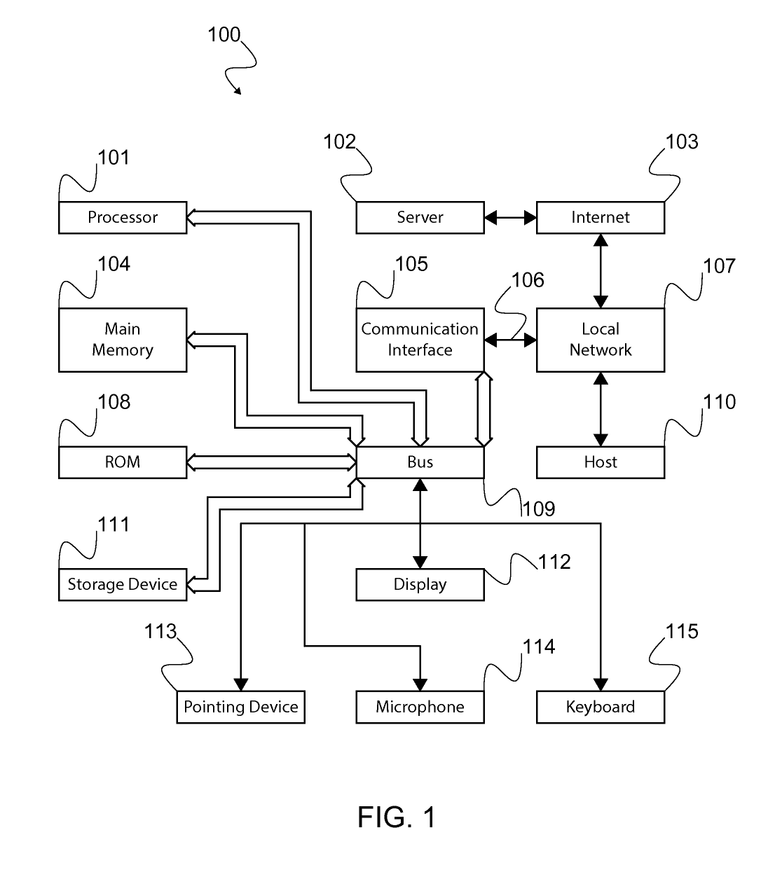

FIG. 1 is a block diagram of a computer system 100 upon which an embodiment of the invention may be implemented. The computer system 100 includes a bus 109 or other communication mechanism for communicating information, and a processor 101 coupled with the bus 109 for processing information. The computer system 100 also includes a main memory 104, such as a random access memory or other dynamic storage device, coupled to the bus 109 for storing information and instructions to be executed by the processor 101. The main memory 104 also may be used for storing temporary variable or other intermediate information during execution of instructions to be executed by the processor 101. The computer system 100 further includes a read only memory 108 or other static storage device coupled to the bus 109 for storing static information and instructions for the processor 101. A storage device 111, such as a magnetic disk or optical disk may also be provided and coupled to the bus 109 for storing information and instructions.

The computer system 100 may be coupled via the bus 109 to a display 112, such as a cathode ray tube, for displaying information to a computer user. Such a display 112 may also include an LCD display, plasma display, laptop screen, portable phone screen, any kind of touch-screen for any computing device, or other type of display or user interface. A keyboard 115 including alphanumeric and other keys, is coupled to the bus 109 for communicating information and command selections to the processor 101.

Another type of user input device is the microphone 114. The microphone 114 may be built in to the computer system 100, such as an internal microphone within a desktop computer, laptop, tablet, or cell phone. The microphone 114 may also be an external device and thereafter coupled to the bus 109.

A further type of user input device is the pointing device 113. This may be a mouse, a trackball, trackpad, smart-mouse, smart-trackpad, or cursor direction keys for communicating direction information and command selections to the processor 101 and for controlling cursor movement on the display 112. This input device typically has two degrees of freedom in two axes, a first axis and a second axis that allows the device to specify positions in a plane. The pointing device 113 may further utilize touch-screen technology such that a user's finger or fingers act as the pointing device to command selections to the processor 101 and for controlling movement on the display 112.

The invention is related to the use of the computer system 100 for practicing the system and method for memorizing a narrative. According to one embodiment of the invention, practicing the system and method for memorizing a narrative is provided by the computer system 100 in response to the processor 101 executing one or more sequences of one or more instructions contained in the main memory 104. Such instructions may be read into the main memory 104 from another computer-readable medium, such as the storage device 111. Execution of the sequences of instructions contained in the main memory 104 causes the processor 101 to perform the process steps described herein. One or more processors in a multiprocessing arrangement may also be employed to execute the sequences of instructions contained in the main memory 104. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to the processor 101 for execution. Such a medium may take many forms, including, but not limited to, non-volatile media, volatile media, and transmission media. Non-volatile media include, for example, optical or magnetic disks, such as the storage device 111. Volatile media include dynamic memory, such as the main memory 104. Transmission media include coaxial cables, copper wire, and fiber optics, including the wires that comprise the bus 109. Transmission media can also take the form of acoustic or light waves, such as those generated during radio frequency and infrared data communications. Common forms of computer-readable media include, floppy disk, a flexible disk, flash disk, hard disk, magnetic tape, any other magnetic medium, a CD-ROM, DVD, any other optical medium, punch cards, paper tape, any other physical medium with patterns of holes, a RAM, a PROM, an EPROM, a FLASHEPROM, any other memory chip or cartridge, a carrier wave, or any other medium from which a computer can read.

Various forms of computer-readable media may be involved in carrying one or more sequences of one or more instructions to the processor 101 for execution. For example, the instructions may initially be born on a magnetic disk of a remote computer. The remote computer can load the instructions into its dynamic memory and send the instructions over a telephone line using a modem. A modem local to the computer system 100 can receive the data on the telephone line and use an infrared transmitter to convert the data to an infrared signal. An infrared detector coupled to the bus 109 can receive the data carried in the infrared signal and place the data on the bus 109. The bus 109 carries the data to the main memory 104, from which the processor 101 retrieves and executes the instructions. The instructions received by the main memory 104 may optionally be stored on the storage device 111 either before or after execution by the processor 101.

The computer system 100 also includes a communication interface 105 coupled to the bus 109. The communication interface 105 provides a two-way data communication coupling to a network link 106 that is connected to a local network 107. For example, communication interface 105 may be an integrated services digital network card or a modem to provide a data communication connection to a corresponding type of telephone line. As another example, the communication interface 105 may be a local area network card to provide a data communication connection to a compatible local area network. Wireless links may also be implemented. In any such implementation, the communication interface 105 sends and receives electrical, electromagnetic, or optical signals that carry digital data streams representing various types of information.

The network link 106 typically provides data communication through one or more networks to other data services. For example, the network link 106 may provide a connection through the local network 107 to a host 110 computer or to data equipment operated by an Internet Service Provider (ISP). The ISP in turn provides data communication services through the world wide packet data communication network, now commonly referred to as the Internet 103. The local network 107 and Internet 103 both use electrical, electromagnetic, or optical signals that carry digital data streams. The signals through the various networks and the signals on the network link 106 and through the communication interface 105, which carry the digital data to and from the computer system 100, are exemplary forms of carrier waves transporting the information.

The computer system 100 can send messages and receive data, including readable program codes, through the network, network link 106, and the communication interface 105. In the Internet example, a server 102 might transmit a requested code for an application program through the Internet 103, ISP, the local network 107, and the communication interface 105. In accordance with the invention, one such downloaded application provides for practicing the system and method for memorizing a narrative as described herein. The received code may be executed by the processor 101 as it is received, and/or stored in the storage device 111, or other non-volatile storage for later execution. In this manner, the computer system 100 may obtain an application code in the form of a carrier wave.

The computer system 100 may include a personal computing device such as a desktop computer, a laptop computer, a cell phone, smart-phone, tablet, other computing device, or other user interface. The particular hardware, however, may only affect the means on how data is entered into and received from the computer system 100.

For example, a user using a desktop computer may type word for word a particular narrative to memorize utilizing the keyboard 115, which may be connected to the main memory 104 via the bus 109 and stored for later retrieval. Another user may utilize a laptop computer to achieve essentially the same result, but rather copy and paste a particular narrative using the pointing device 113 and the keyboard 115 connected to the main memory 104 via the bus 109 and stored for later retrieval. Yet another user may utilize the touch-screen of a smart-phone, which as described above would be a variation on using the pointing device 113, such that the pointing device is actually a user's finger or fingers acting as the pointing device 113 to command selections to the processor 101 and for controlling movement on the display 112. In this scenario, a user could use copy and paste commands and/or functions, or type a narrative with an electronic keyboard 115 to be stored in the main memory 104. Still, another user may take advantage of a computer system 100 and speech recognition technology, and speak a narrative into the microphone 114, which may also be connected to the main memory 104 via the bus 109 and stored for later retrieval.

In regard speech recognition technology, it may be noted that this includes voice recognition technology. Speech recognition is the broader term, whereas voice recognition is limited to one person's particular voice. In an acting scenario, for example, two thespians may elect to utilize voice recognition technology with a capable computer system 100 such that the computer system 100 is able to distinguish between each thespian's voice and the particular lines that each is attempting to memorize. Where the first thespian began to speak, the voice recognition technology of the computer system 100 would recognize the first thespian's voice. After finishing her line, the computer system 100 would recognize that it was time for the second thespian to recite her line. How the computer system 100 recognizes particular voices will be discussed in further detail below.

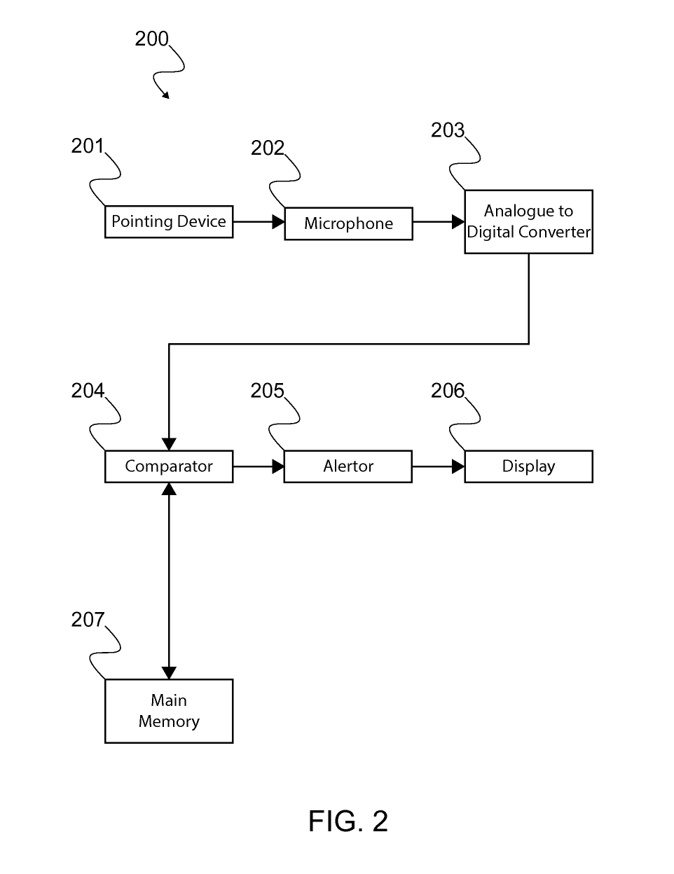

FIG. 2 is a block diagram of a system 200 for memorizing a narrative. In this particular embodiment, a user may begin the process of memorization by navigating on her computer to the place where she has stored her particular narrative for memorization utilizing the pointing device 201. This may be within the main memory 207 of the computer. She may then open the narrative and then click within the narrative with the pointing device 201 in the place where she wishes to begin and thereby engage the system 200. Once engaged, she may begin to speak into the microphone 202. Her utterances are then passed through the analogue to digital converter 203 of the system 200 being transformed into digital signals, which may include digital text. These signals are then processed through the comparator 204, which compares her converted utterances in near real-time with the narrative stored within the main memory 207 of the system 200. The comparator 204 may be comprised of readable code stored within the main memory 207 of the computer, said code further comprising instructions to compare the analogue utterances or inputs with the narrative, also stored within the main memory 207 of the computer. When the utterances match the stored narrative, the user is able to continue speaking. When the utterances do not match, the alerter 205 signals to the user that she made a mistake. The alerter 205 may comprise of readable code stored within the main memory 207 of the computer, said code further comprising instructions for the computer to send a beep, buzz, noise, or other alert to the user. This mistake may also be highlighted on the display 206 of the system 200.

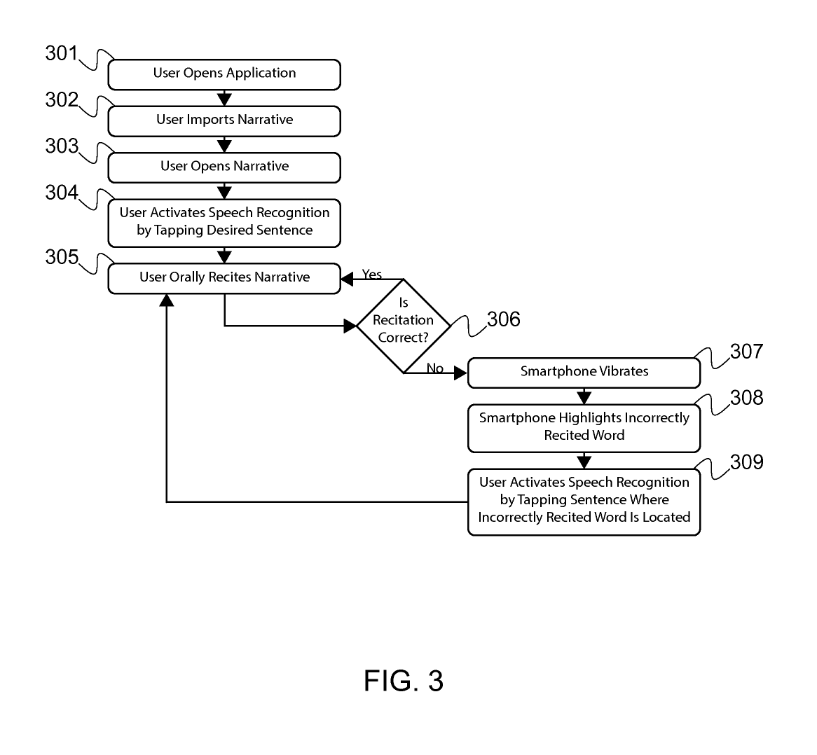

FIG. 3 depicts a user based flowchart implementing the system and method of memorizing a narrative utilizing a smart-phone. The first step that a user would take would be to open the application on the smart-phone 301. The user may then import a narrative of her choosing 302. However, as will be discussed below, the user may have other options available to her when choosing a narrative and how to make it accessible from the main memory. Next, the user would then open the narrative 303. The narrative would appear on the screen of the smart-phone. The narrative would also be navigable, such that the user could move from the beginning of the narrative to the end of the narrative to choose a place to begin the process of memorization. In a particularly long narrative, such as a book, the first portion of the narrative that the user may see would be a table of contents with indexed links, such as to save the user time when navigating to a particular spot to begin the process of memorization.

Once the user finds the place where she is to begin memorizing, she may then activate the speech recognition aspect of the system by tapping the desired sentence 304. This may be a single tap, a double tap, a tap and hold, or other means. Alternatively, the user may click a button on any part of the smart-phone which may activate the speech recognition process wherein the user would start reciting the uppermost visible text on the screen of the phone. In any event, once the system is activated, the user may then orally recite the narrative 305. The system would then analyze whether the recitation was correct 306 by comparing the orally recited narrative with the narrative stored in the main memory of the system.

With a correct recitation of the narrative, the user would be able to continually recite the narrative 305. With an incorrect recitation of the narrative, the user would feel the smart-phone vibrate 307. The user may set up the device to give her other types of alerts, if she so desired, such as a ring, beep, or other types of alerts. The smart-phone would then highlight the incorrectly recited word 308. After seeing her mistake, the user would then activate the speech recognition process by tapping the sentence where the incorrectly recited word is located 309. The user may alternatively choose another location within the narrative from which to embark. The user would then continue to orally recite the narrative 305.

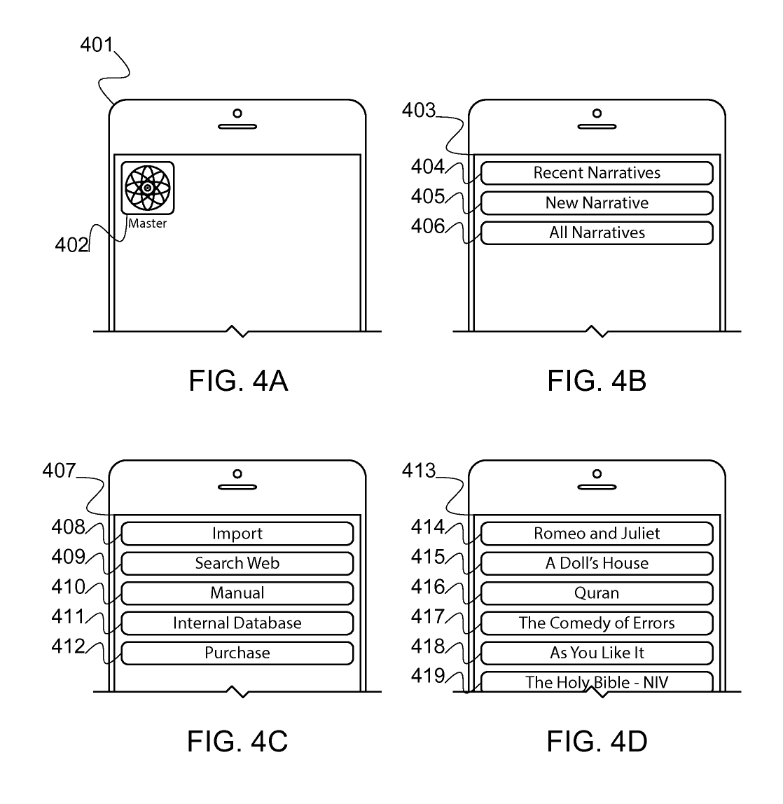

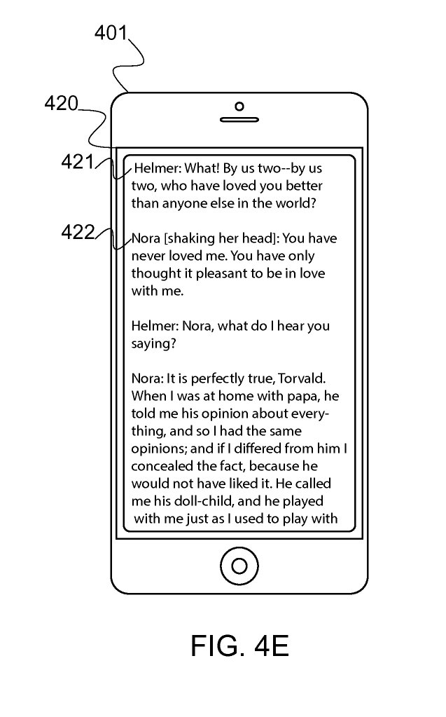

FIGS. 4A-4E depict plan views of a smart-phone 201 at different stages in the process of utilizing the system and method for memorizing a narrative. In the event that the system and method for memorizing a narrative is implemented using a smart-phone 401, the process for memorization may begin by a user logging into an application 402 on the smart-phone 401. The application 402 could be identified by either a name, a symbol, or both, as illustrated in FIG. 4A. A user may login to the application by clicking or touching the icon representing the application 402.

After logging in, the user may be directed to a first screen 403 that gives the user options to choose from, as depicted in FIG. 4B. Such options may include Recent Narratives 404, New Narrative 405, and/or All Narratives 406. Other options may also be included on the first screen 403. As with logging into the application 402, a user may select an option by clicking or touching the icon representing the option.

FIG. 4C depicts a second screen 407 that a user may be taken to when selecting the New Narrative 405 option. More options may then be populated on the second screen 407 including an Import 408 option, a Search Web 409 option, a Manual 410 option, an Internal Database 411 option, and a Purchase 412 option. Other options may also be included.

If a user were to select the Import 408 option, the user may be prompted to import, for example, a word document, a pdf, an image, or other type of document containing text. This document may then be imported and stored within the memory of the application.

If a user were to select the Search Web 409 option, the user may be prompted into a web browser to search for specific content to import and store within the memory of the application. The user, for example could find a specific passage on the Internet, select it by highlighting it, and be given an option to import the selected text.

If a user were to choose the Manual 410 option, the user may then be taken to another blank screen and allowed to manually insert the text that she desired to memorize. She may insert this text by using the digital keyboard of the smart-phone, or alternatively by utilizing speech recognition technology to utter a passage to be stored within the memory of the application. Such a passage may initially be read from another source document, and this would also allow for the user to save time in the memorization process because she would actually begin the memorization process by manually inserting it into the application itself.

If a user were to choose the Internal Database 411 option, she may be directed to another screen having any narratives already stored within the memory of the system upon downloading the initial software. Thus, a user may have access to narratives that may be included, for example, with the purchase of the software, such as registered copyrighted works, unregistered works, works in the public domain, or any other narrative in which could be preinstalled within the memory of the system.

FIG. 4D depicts a third screen 413 that a user may be escorted to when choosing the All Narratives 406 option from the first screen 403. As shown, the narratives may include all of the narratives that a user may have stored in the memory of the system. For example, such narratives may include Romeo and Juliet 414, A Doll's House 415, Quran 416, The Comedy of Errors 417, As You Like It 418, and The Holy Bible-NIV 419. Again, it may be noted that the user may choose any particular narrative. A narrative may include a play, a script, a book, an outline, a definition, a series of words and/or phrases, and so on. There are no practical limitations on the types of narratives that a user may attempt to commit to memory.

FIG. 4E depicts a fourth screen 420 that a user may be directed to when selecting a particular narrative. Here, for example, the user selected A Doll's House 415 from FIG. 4D. Depending on where the user left off in the process of memorization, the system may be programmed to bookmark the last known position within the narrative such that when the user reopens the narrative, she will be directed to the bookmarked position. With a new narrative, however, the user may be directed to the first word of the first page.

FIG. 4E depicts a bookmarked position. In order to continue the process of memorization, the user may read to herself the first line 421, and try to internalize it. To test her knowledge of the first line 421, she may then double tap the first line 421. This may activate the speech recognition component of the system. Other means of activating the speech recognition component may be utilized. For example, a single tap may accomplish the same result. Another button on the smart-phone 401 may be pressed as well. Other means are also possible.

The user may then speak the first line 421 into the microphone of the smart-phone which may then be converted to from analogue sound to digitized text or signals by the processor, and compared with the text already stored in the memory. So long as each word of the spoken narrative matches with the text stored within the database, the user will be able to continue word by word speaking the memorized narrative, and eventually move on to the second line 422. It may also be noted that the user may utilize headphones connected to the smart-phone 401 and speak into the microphone of the headphones. It may further be noted that the user may activate the speech recognition component of the system by depressing a particular button on the headphones themselves.

In the event that that the user makes a mistake in reciting the narrative she may be notified by the smart-phone in a variety of ways. For example, the smart-phone may make a short vibration, signaling a mismatch between what the user stated and what is stored on the memory. Other methods of notification may include the smart-phone making an audible noise, such as a beep. The system may even be programmed such that the phone makes a comment, such as “Oops,” or “Uh-oh,” or “try again,” or other phrases. Of course, as these are merely illustrative, other comments or noises could be made. Another method of notification may include the phone being programmed to state the word that was mismatched. A further method of notification may include the phone being programmed to restate the entire phrase to put the mismatch in context for the user.

An issue may arise as to the format of the narrative, and what is relevant for reciting, and ultimately, memorization. For example, in regard to FIG. 2E, it may be noted that there are two characters forming the narrative, Helmer and Nora. It may also be noted that there is bracketed text within the second line 422 that suggests physical movement, rather than verbalization, for the character to make. The system may be programmed such that text of this type is not included when the processor compares what a user recites compared to what is stored in the memory.

Although some of the methods of importing may make this process difficult to achieve, it may be addressed with narratives that are already stored on the Internal Database 411. It may also be addressed with narratives purchased using the Purchase 412 option in FIG. 4C. For example, when the user presses the Purchase 412 option, she may be directed to a third party website that specifically codes narratives that are compatible with the system and user friendly, such that when the user begins her recitation utilizing the speech recognition component of the system, she is only reciting the relevant portions of what she needs to know. Returning the first line 421 of FIG. 4E, this means that the user, after activating the speech recognition component, could naturally begin with the first word of the narrative, which is “What!,” and then continue on with “By us two-by us two, who have loved you better than anyone else in the world?” She may then deactivate the system by any means previously discussed.

After the user has been notified that she made a mistake, the speech recognition component of the system may be deactivated. The user may then have to reactivate the speech recognition component by any of the means described above, or other means. She may also start within the narrative wherever she may please. This may include the sentence where she made her mistake. She may also start a few lines before the mistake, or anywhere else within the narrative. She may then go on to repeat this process until she has the entirety of the narrative committed to memory such that she may orally recite it without receiving notification errors from the system.

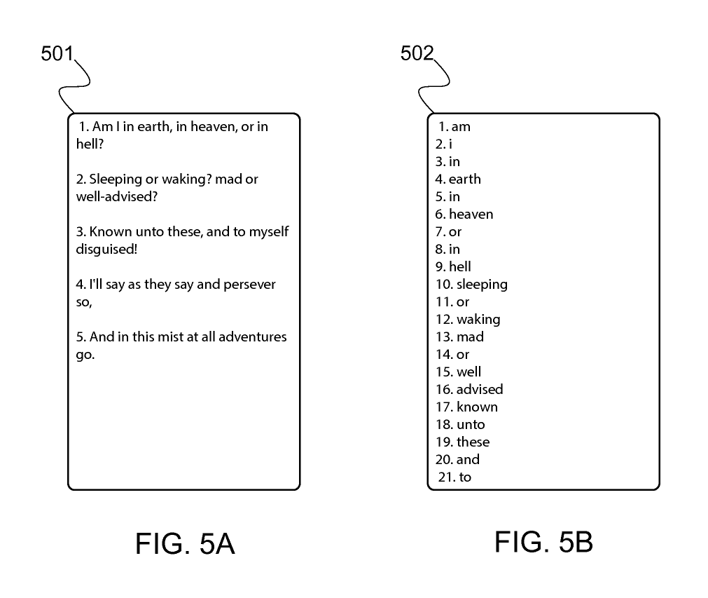

FIG. 5A depicts a transcript 501 of a particular narrative. This transcript, it may be noted, is from a play, and does not include any text that the actor would not normally speak, such as character names, physical prompts, and so on. This transcript may be viewable from the video display of a smart-phone, other computing device or user interface, or from a piece of paper, granted that it is stored with the memory of the device to be effective. FIG. 5B is a depiction the narrative from FIG. 5A as stored in the memory of the system as an ordered narrative 502. Here, a user may activate the speech recognition component of the system and begin reading her lines, beginning with the word “Am” of the first line. From the moment of her speaking this first word, it would be transmitted via the microphone, through the bus and to the processor, where it may be converted into a digital signal and compared with the first word in the ordered narrative 502 “am.” The processor would then determine if the spoken word matched the ordered word. If it matched, it would continue to receive user input.

If there was a mismatch, the processor may alert the user as described above. For example, if a user stated “and” in the first line rather than the required “or” the processor would recognize in line 7 of the ordered narrative 502 the mismatch, stop receiving input, and notify the user.

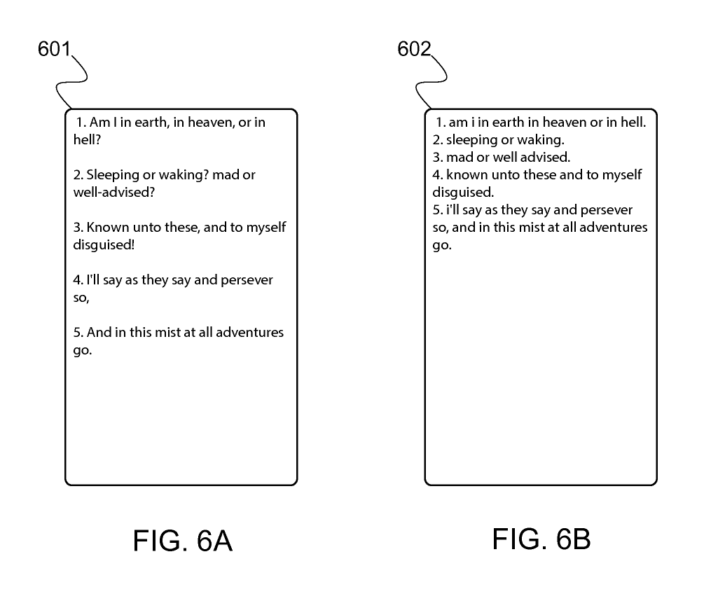

FIGS. 6A and 6B depict an alternative embodiment. FIG. 6A again depicts a transcript 601 while FIG. 6B depicts an ordered narrative 602. The difference may be noted in how the ordered narrative 402 is structured, and how information is processed, which is sentence by sentence rather than word by word. As such, the user may begin speaking from the first line “Am I in earth, in heaven, or in hell?” which the processor may then convert and match word for word as each word is spoken. In the event of a mistake, however, the user would not be notified until she finished the sentence as marked by the period in the first line of the ordered narrative. This may allow for a user to experience less interruption in the process of memorizing a narrative.

The system may also be configured to recognize punctuation and take or refrain from action based on specified criteria. To return to FIG. 4E to highlight this proposition, it may be noted that in many plays, punctuation takes on specified meanings. For example, the colon after “Helmer” in the first line 421 denotes that this is Helmer's line to speak. The system may be programmed such that anytime there is a colon, it recognizes not to order the immediately preceding word or words. To illustrate further, with the second line 422, the colon is preceded by “? Nora [shaking her head].” The system may be programmed such that the text beginning with the final question mark of the first line 421 to the colon is not ordered for comparison.

Another example of the system being programmed to recognize punctuation marks may be noted again with the second line 422 of FIG. 4E. Here there is bracketed text, “[shaking her head].” The system may be programmed such that any time that it recognizes text within brackets, it knows to not order the text for speech comparison purposes.

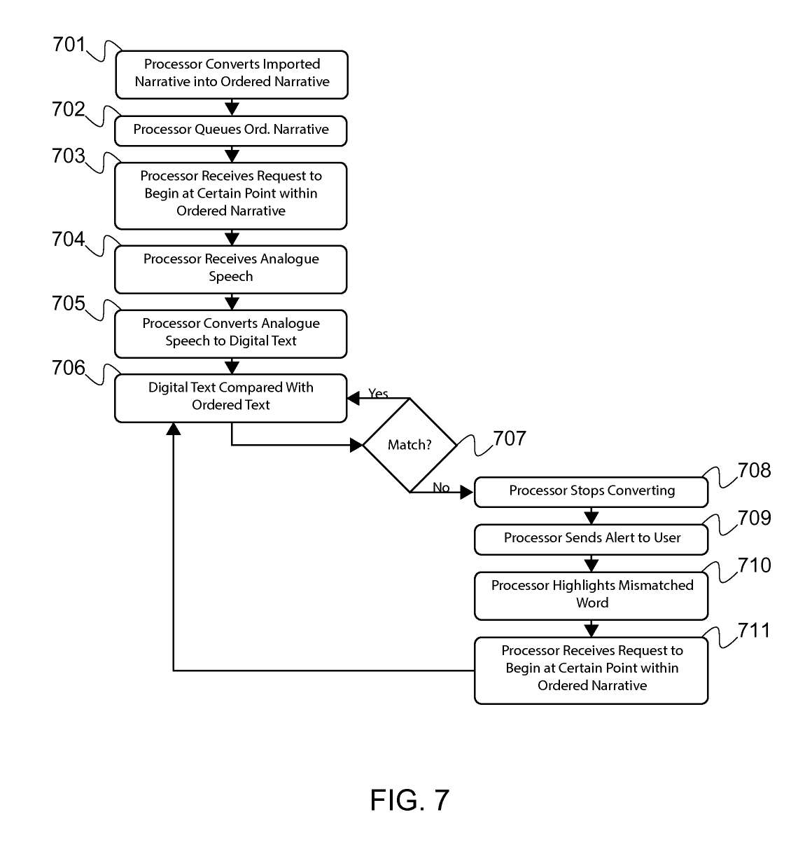

FIG. 7 depicts a processor based flowchart implementing the system and method utilizing a computing device. First, the processor would convert the imported narrative into a ordered narrative 701. The processor would then queue up the ordered narrative to compare to the incoming narrative from the user 702. Next the processor would receive a request to begin at a certain point within the ordered narrative 703. Once the user began to recite the narrative, the processor would receive analogue speech 704, which it would convert to digital text to be compatible with the text stored in the ordered narrative 705. Once converted, the processor would then be able to compare the digitized text with the ordered text on a word for word basis 706. That is, as each spoken word was processed through the system, each word would be compared in linear fashion. The processor would then determine if each word matched the narrative stored within the main memory of the system 707.

In the event that the comparisons continuously matched, the processor would continue to compare the digital text with the ordered text 706. Where there was a mismatch, the processor would change course by stopping the conversion and comparison process 708. The processor would then send an alert to the user 709 and highlight the mismatched word 710. When the user decided to try again, or begin from a new location, the processor would receive a request from the user to begin anew and at whatever point the user chose within the ordered narrative 711. The process would continue along this or a similar cycle for as many times as necessary.

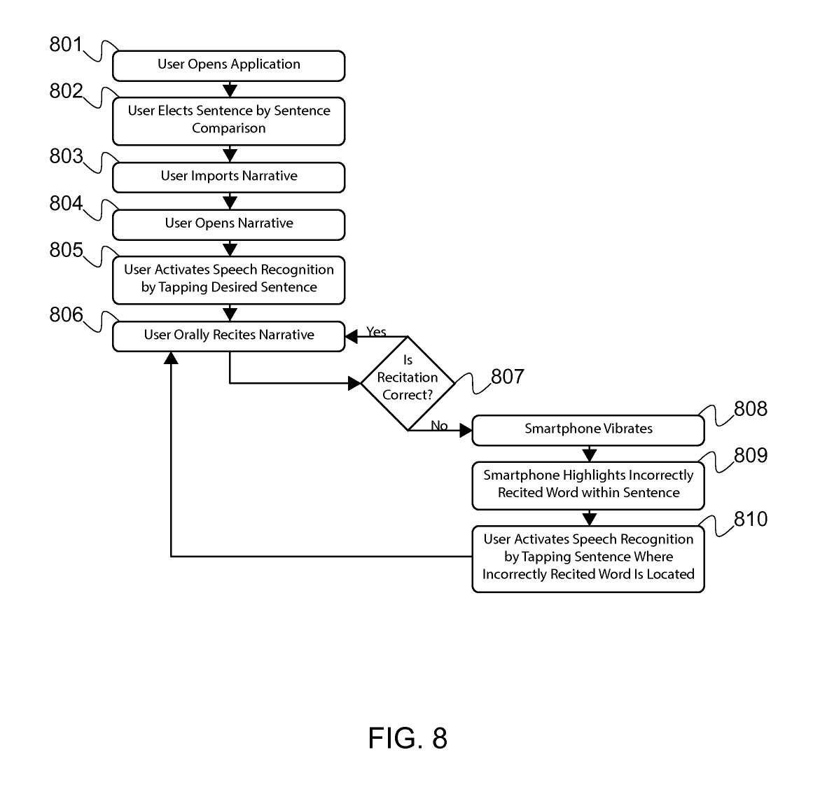

FIG. 8 depicts a user based flowchart implementing an alternative method for memorizing a narrative utilizing a smart-phone. First the user would open the application 801 at which point she could then elect what type of comparison she would like to use. Here, the user elects sentence by sentence comparison 802. This allows the user some flexibility in the process of memorization, which can be a taxing process. Rather than being interrupted at each juncture where she mispronounced a word, this selection would only alert her at the conclusion of her sentence. The user would then import the narrative 803, open the narrative 804, and activate the speech recognition process by tapping on the desired sentence 805. She would then orally recite the narrative 806, and the system would make a determination if the recitation was correct 807. If she recited correctly, she could continue interruption free to orally recite the narrative 806.

With incorrect recitation, the smart-phone would vibrate 808. However, the smart-phone would not vibrate until the conclusion of her sentence alerting the user of her mistake. Although the smart-phone would wait until the user finished her sentence, the smart-phone would still precisely highlight the particular word that was incorrectly recited 809. The user could then reactivate the speech recognition by tapping the sentence where the incorrectly recited word is located 810 and continue to orally recite the narrative 806.

A system and method for memorizing a narrative has been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

What is claimed is:

1. A user interface, comprising a computer-readable medium having a readable program code embodied in the computer-readable medium, the readable program code adapted to be executed to implement a method for memorizing a narrative, the method comprising:
receiving a first narrative;
storing the first narrative in the memory;
receiving a second narrative;
comparing the first narrative to the second narrative;
determining whether the first narrative matches the second narrative; and
generating an alert when comparing the first narrative to the second narrative reveals one or more discrepancies between the first narrative and the second narrative.

2. The user interface of claim 1, wherein receiving the first narrative comprises receiving a digital input.

3. The user interface of claim 1, wherein receiving the first narrative comprises receiving an analogue input.

4. The user interface of claim 1, wherein receiving the second narrative comprises converting an analogue input into a digital input.

5. The user interface of claim 1, wherein storing the first narrative includes storing one or more punctuation characters, wherein the one or more punctuation characters serve the purpose of dividing the first narrative into one or more sentences.

6. The user interface of claim 5, wherein the comparison of the first narrative to the second narrative is in near real-time.

7. The user interface of claim 6, wherein the alert is generated immediately upon detection a discrepancy is revealed when comparing the first narrative to the second narrative.

8. The user interface of claim 6, wherein the user interface recognizes a discrepancy when comparing the first narrative to the second narrative, and wherein the alert is sent at the conclusion the comparison of the one or more sentences.

9. The user interface of claim 5, wherein the user interface recognizes one or more punctuation characters within the first narrative, removes a portion of the first narrative within the one or more punctuation characters, and then compares the first narrative to the second narrative.

10. A device for facilitating memorization of a narrative, comprising:
a user interface;
a processor;
a memory; and
one or more programs stored in the memory and configured to be executed by the processor, the one or more programs including:
instructions for receiving a first narrative;
instructions for storing the first narrative in the memory;
instructions for receiving a second narrative;
instructions for comparing the first narrative to the second narrative;
instructions for determining whether the first narrative matches the second narrative; and
instructions for sending an alert when comparing the first narrative to the second narrative reveals discrepancies.

11. The device of claim 10, wherein instructions for receiving the first narrative comprise instructions for receiving a digital input.

12. The device of claim 10, wherein instructions for receiving the first narrative comprise instructions for receiving an analogue input.

13. The device of claim 10, wherein instructions for receiving the second narrative comprise instructions for converting an analogue input into a digital input.

14. The device of claim 10, wherein instructions for storing the first narrative include instructions for storing one or more punctuation characters, wherein the one or more punctuation characters serve the purpose of dividing the first narrative into one or more sentences.

15. The device of claim 14, wherein instructions for comparing the first narrative to the second narrative further comprise instructions to compare in near real-time.

16. The device of claim 15, wherein instructions for sending the alert further comprise instructions to immediately send the alert when a discrepancy is revealed when comparing the first narrative to the second narrative.

17. The device of claim 15, wherein the one or more programs recognize a discrepancy when comparing the first narrative to the second narrative, and wherein instructions for sending the alert further comprise instructions to send the alert at the conclusion the comparison of the one or more sentences.

18. The device of claim 14, wherein the computer program recognizes one or more punctuation characters within the first narrative, and further comprises instructions to remove a portion of the first narrative within the one or more punctuation characters, and instructions to compare the first narrative to the second narrative.

19. A method for memorizing a narrative via a user interface, comprising:
receiving, by the user interface, a first narrative wherein receiving the first narrative comprises receiving a digital input;
storing the first narrative in a memory accessible by the user interface, wherein storing the first narrative includes storing one or more punctuation characters, wherein the one or more punctuation characters serve the purpose of dividing the first narrative into one or more sentences;
receiving, via the user interface, a second narrative wherein receiving the second narrative comprises converting an analogue input into a digital input;
comparing the first narrative to the second narrative, wherein the comparison of the first narrative to the second narrative is in near real-time;
determining whether the first narrative matches the second narrative; and
sending an alert when comparing the first narrative to the second narrative reveals discrepancies, and wherein the alert is immediately sent when a discrepancy is revealed when comparing the first narrative to the second narrative.

20. The method of claim 19, wherein the computer program recognizes a discrepancy when comparing the first narrative to the second narrative, and wherein the alert is sent at the conclusion the comparison of the one or more sentences.
